(19) United States
(12) Patent Application Publication
(10) Pub. No.: US 2010/0157040 A1
(43) Pub. Date: Jun. 24, 2010

(54) BIOMETRIC FACIAL SURVEILLANCE SYSTEM

(75) Inventor: Alon OFIR, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Rafael - Armament Development Authority Ltd., Haifa (IL)

(21) Appl. No.: 12/161,006

(22) PCT Filed: Jan. 14, 2007
(86) PCT No.: PCT/IL07/00054

§ 371 Date: Jul. 16, 2008

(30) Foreign Application Priority Data
Jan. 17, 2006 (IL) 173210

(51) Int. Cl. H04N 7/18

(52) U.S. Cl. 348/77; 348/E07.085

(57) ABSTRACT

A biometric facial surveillance system comprise at least one independent, stand-alone biometric unit operative to acquire and process biometric parameters to provide a complete verification or identification of a person. In a preferred embodiment, each biometric unit includes a camera operative to provide a two dimensional (2D) video stream and a 3D pixel depth data stream, and at least one processing unit operative to process the 2D video stream and a 3D pixel depth data stream into biometric parameters that verify or identify the particular person. In alternative embodiments, a plurality of biometric units is connected to a biometric server and an applications server which provide management functions.

### FIELD OF THE INVENTION

The present invention relates in general to biometric systems and methods, and in particularly to biometric surveillance systems and methods that permit identification and verification of a single person or multiple persons in live crowds.

### BACKGROUND OF THE INVENTION

Surveillance (on-line person identification or verification) systems and methods based on face recognition are known, see e.g. the FACEIT ARGUS system from Identix of Minnetonka, Minn., USA. As shown in FIG. 1, known surveillance systems use one or more cameras 102 connected to a computing unit (e.g. a personal computer or “PC”) 104 and to a central server 106 that includes a database 108. The cameras have no independent processing capabilities, and serve solely as information gathering devices. The gathered information is passed on to the PC and/or the central server for processing. The PC normally includes all the functions and algorithms needed to perform the face recognition. Imaging of biometric information based on three-dimensional shapes is also known, see for example US Patent Application No. 20040223630 by R. Waupotitsch et al., which is hereby incorporated by reference.

Basically, all known surveillance systems use the following stages in the performance of face recognition:
a. Face localization: An image acquired by a camera is analyzed to determine the position and size of one or more faces. The following steps are then applied to each face;
b. Eye localization: The positions of the centers of the eye within the face are determined.
c. Image Quality Check: The quality of the face image is checked to see whether it is sufficient for the steps that follow.
d. Normalization: The face is extracted from the image and is scaled and rotated in such a way that the result is a “normalized” image of fixed size, with the centers of the eye at fixed positions within that image.
e. Preprocessing: The normalized image is preprocessed with standard techniques such as histogram equalization, intensity normalization, and others, all well known in the art.
f. Create token image—a token image is created, for example using the NIST ISO 19794-5 standard.
g. Feature extraction: In the preprocessed image, features that are relevant for distinguishing one person from another are extracted.
h. Comparison: For verification, the set of extracted features is compared with the reference set of an individual claimed to be the person in the image just processed. For identification, the feature set is compared to all stored reference sets, and the person with the largest comparison value is selected. In both cases, recognition is considered successful if the (largest) score value exceeds a certain threshold value.

Most existing biometric based technologies have false alarms in the form of a certain percentage of false matches (i.e. fault rejection rate or FRR) or false mismatches (i.e. fault acceptance rate or Far)). Known systems based on these technologies do not know how to compensate for such misses. Existing products that use more than one algorithm belonging to different technologies for face recognition in a fusion procedure use only proprietary algorithms. There is no known “generic” fusion engine that can use two or more “off-the-shelf” (also referred to herein as “generic”) algorithms from different technology approaches.

There is therefore a widely recognized need for, and it would be highly advantageous to have, a biometric facial surveillance system that may be implemented in independent, stand-alone biometric units, which can, in a generic way, fuse data processed by two or more algorithms to obtain highly accurate and error-free verification or identification of an individual or a plurality of individuals in a crowd.

### SUMMARY OF THE INVENTION

The present invention discloses a system and method for biometric facial surveillance using a stand-alone biometric unit. In some embodiments, a plurality of such biometric units is connected to and interacting with a biometric and demographic server (referred to herein as “biometric server”) and to an applications server. In the latter case, the biometric and applications servers provide management functions, the system then also referred to as a “surveillance and management” system. Preferably, each biometric unit includes a 3-dimensional (3D) camera. A 3-D camera that may be used for the purposes of the present invention is exemplarily described in U.S. Pat. No. 6,100,517 to G. Yahav and G. Iddan, which is hereby incorporated by reference. The “stand-alone” feature means that the biometric unit operates independently, using its own processing capability to assume functions performed in prior art by a separate unit (e.g. a PC). This lessens the processing load imposed on additional units such as a PC and for a server, when a biometric unit is connected to such. The load may be due to a large number of individuals needing checking The biometric unit repeatedly probes the faces of individuals who pass through a defined area in a given time period, each probe resulting in information flow. In some embodiments, the biometric units may be connected to other units and to the servers through a network. In this case, the biometric units are operative to exchange information on objects found within their respective fields of view.

The biometric units of the present invention do not perform a 3D identification, but use a 3D camera input for a first preprocessing step in a two-dimensional (2D) identification operation. The camera in each biometric unit provides two information streams: a standard analog video stream (2D) and a pixel depth information stream (3D). Both streams are preferably provided at a minimum rate of 25 Hz. The video stream is used to find faces, while the pixel depth stream is used to build a 3D model of the face (i.e. perform the first four steps of the standard recognition process described above, up to and including normalization). The normalization procedure may follow that described in detail in Israel Patent Application No. 168035 by T. Michaely, dated 14 Apr. 2005 and titled “Face Normalization for Recognition and Enrollment”, which is hereby incorporated by reference. The normalization provides a normalized frontal view of each face. The normalized view is used to produce a canonical face view, also called “token image”, which in turn is used to extract biometric parameters such as, but not limited to, head size, eye location and distance between the eyes.

According to the present invention there is provided a biometric facial surveillance system comprising at least one independent, stand-alone biometric unit operative to acquire and process biometric parameters to provide a complete verification or identification of a person.

According to one feature in the biometric facial surveillance system of the present invention, each biometric unit includes a camera operative to provide a two dimensional (2D) video stream and a 3D pixel depth data stream, and at least one processing unit operative to process the 2D video stream and the 3D pixel depth data stream into the biometric parameters.

According to another feature in the biometric facial surveillance system of the present invention, the at least one biometric unit includes two processing units, a first processing unit operative to provide at least two biometric templates based on at least two different biometric algorithms and a second processing unit operative to perform a face matching operation and a data fusion operation using the at least two biometric templates provided by first processing unit.

According to yet another feature in the biometric facial surveillance system of the present invention, the system further comprises a biometric server operative to exchange biometric information with each biometric unit and to facilitate information exchange between different biometric units.

According to yet another feature in the biometric facial surveillance system of the present invention, the system further comprises an applications server functionally connected to the biometric server and operative to perform a host of client functions.

According to the present invention there is provided a biometric facial surveillance system comprising at least one independent, stand-alone biometric unit operative to acquire and process biometric parameters to provide a complete verification or identification of a person, wherein each biometric unit includes a camera operative to acquire facial information on individuals in a crowd, and at least one processing unit operative to process the acquired facial information into biometric parameters used to verify or identify a specific individual, wherein the processing unit includes a data fusion module operative to fuse data obtained from two different matching engines using two different biometric algorithms.

In some embodiments of the system, the system includes a single biometric unit.

In other embodiments of the system, the system includes a plurality of biometric units interacting through a biometric server.

According to the present invention there is provided a biometric facial surveillance system comprising a stand-alone biometric unit operative to acquire biometric facial information and to process this information into a match image using at least two different algorithms, whereby the match image can be used in the identification or verification of an individual in real time.

According to one feature of the biometric facial surveillance system comprising a stand-alone biometric unit, the biometric unit includes a camera operative to provide biometric facial information, at least one processing unit operative to process the biometric facial information using the plurality of different biometric algorithms into a matching plurality of different biometric templates, a plurality of matching engines, each engine operative to receive a respective biometric template, each engine operative to conduct 1:N searches against a watch list database and to provide a respective matching engine output, and a data fusion module operative to fuse the matching engine outputs with data obtained from a watch list in order to provide the match image.

In some embodiments of the biometric facial surveillance system comprising a stand-alone biometric unit, at least one of the biometric algorithms is generic.

In some embodiments of the biometric facial surveillance system comprising a stand-alone biometric unit, all the biometric algorithms are generic.

According to the present invention there is provided a method for obtaining real time identification or verification of a person based on biometric facial information, comprising the steps of providing a stand-alone biometric unit, and operating the biometric unit to acquire biometric facial information and to process this information into a match image using at least two different algorithms, whereby the match image can be used in the real time identification or verification.

According to one aspect of the method of the present invention, the step of providing a stand-alone biometric unit comprises providing a biometric unit that includes a camera operative to provide biometric facial information, at least one processing unit operative to process the biometric facial information using the plurality of different biometric algorithms into a matching plurality of different biometric templates, a plurality of matching engines, each engine operative to receive a respective biometric template, each engine operative to conduct 1:N searches against a watch list database and to provide a respective matching engine output, and a data fusion module operative to fuse the matching engine outputs with data obtained from a watch list in order to provide the match image.

### BRIEF DESCRIPTION OF THE DRAWINGS

For a better understanding of the present invention and to show more clearly how it could be applied, reference will now be made, by way of example only, to the accompanying drawings in which:

FIG. 1 shows schematically a typical prior art surveillance system;

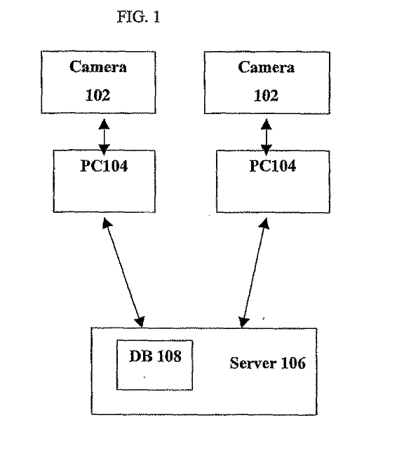

FIG. 2 shows a schematic description of a biometric facial surveillance and management system of the present invention;

FIG. 3a shows a detailed schematic view of a biometric unit of the present invention with a single processing unit. The biometric unit is shown connected to a biometric server and an applications server;

FIG. 3b shows a detailed schematic view of a biometric unit of the present invention with two processing units. The biometric unit is shown connected to a biometric server and an applications server.

### DETAILED DESCRIPTION OF THE INVENTION

The present invention discloses a system and method for biometric facial surveillance using stand-alone biometric units. Each biometric unit may operate individually and independently of other units. Optionally, two or more units may be connected through a network, interacting with each other through one or more servers. The method uses a plurality of biometric algorithms (e.g. in case of two algorithms an “Eigen face” algorithm and a “Fisher face” algorithm), to extract in real time biometric parameters. Advantageously, the stand-alone biometric units are operative to provide real time face recognition surveillance with low fault\alarm rates, for example low FRR (fault rejection rate) and low FAR (fault acceptance rate).

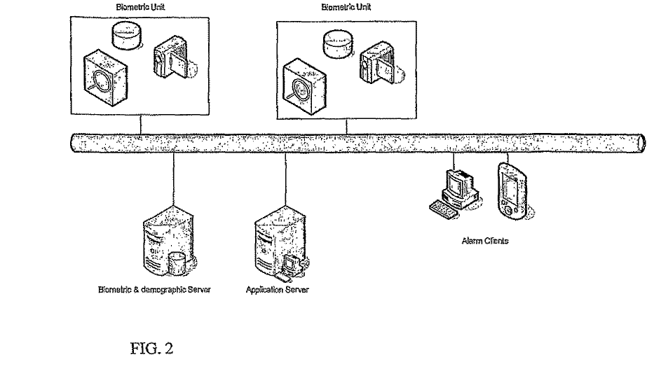

FIG. 2 shows a schematic description of a system of the present invention. Inventively and in contrast with prior art, in a basic embodiment the system comprises a single biometric unit that serves as an independent, stand-alone surveillance device, capable of both acquiring and processing biometric parameters to provide a complete verification or identification. In essence, a biometric unit of the present invention is capable of performing all the functions performed in prior art by separate units, i.e. a camera, a separate PC and a separate server. In some embodiments in which a plurality of biometric units work cooperatively, the system further comprises a biometric server connected to the biometric units and operative to perform actions described in detail below. In other embodiments, the system may further comprise an applications server connected to the biometric server and through it to each biometric unit and operative to perform actions concerning clients. These actions may include: raising an alarm and distributing the alarm to alarm clients, and saving a log with details of biometric and demographic information from a file that relates to a match image. The application server is also in charge of updating the watch list on the biometric end units.

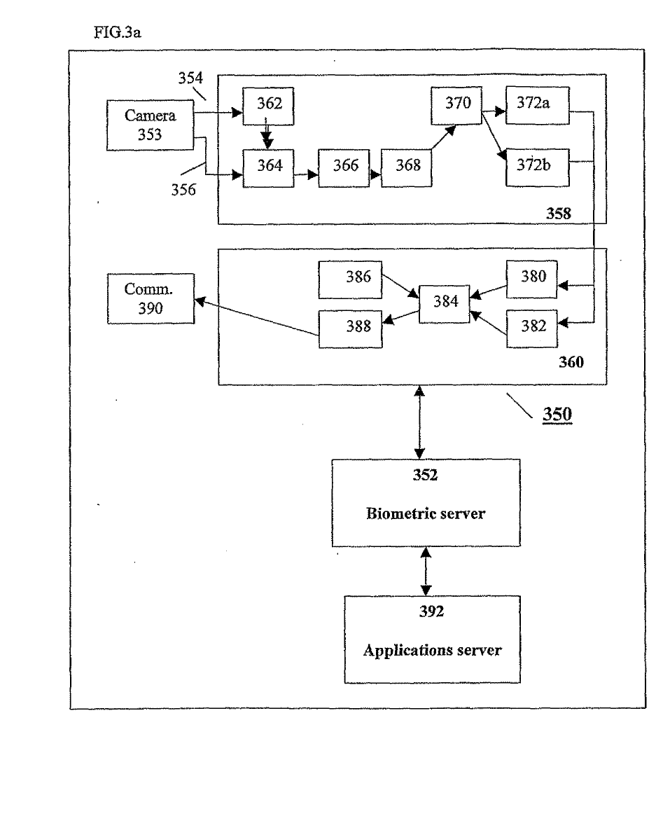

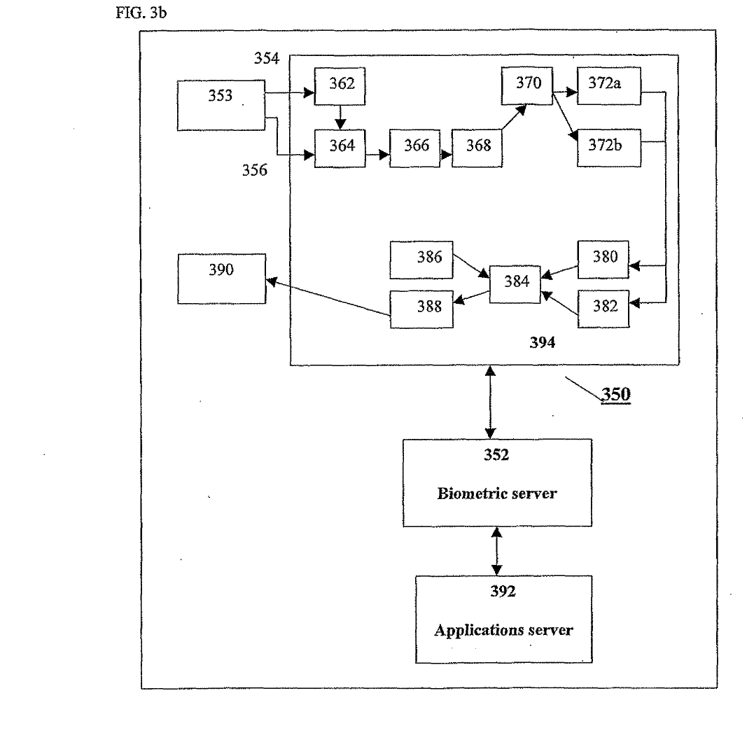

FIG. 3 shows a detailed schematic view of a biometric unit 350 of the present invention, connected to a biometric server 352 and an applications server 392: a) biometric unit with two processing units; a) biometric unit with a single processing unit. To remove any doubt, in FIG. 3 the biometric unit is shown connected to the biometric and applications servers for illustration purposes only. It should be clear that in some embodiments, the biometric unit may stand alone and function independently, not connected to biometric and applications servers.

In FIG. 3a, biometric unit 350 comprises a camera 353 with two outputs, a 2D video stream output 354 and a 3D data stream output 356. Stream 354 is a regular composite video stream and stream 356 is a pixel depth data stream that represents the depth of each pixel in the 2D video stream. The two streams provide frames at a rate of preferably at least 25 Hz. Unit 350 further comprises a first processing unit 358 operative to provide biometric parameters, find faces in a crowd using inputs from stream 354, and normalize the found faces using inputs from stream 356; and a second processing unit 360 operative to perform a face matching operation and a data fusion operation using the biometric parameters provided by unit 358.

First processing unit 358 comprises a “find face” module 362 operative to finds a face in a frame (by using e.g. the well known Viola-Jones algorithm); a 3D face creation module 364 that receives the location of the face in the frame from module 362 and the 3D depth information from stream 356 and creates a 3D model of the face, using for example the Iterative Closest Point (ICP) algorithm described in P. J. Besl and N. D. McKay, “A method for registration of 3-d shapes”, PAMI, 14(2): 239-256, February 1992, or in Y. Chen and G. Medioni, “Object modeling by registration of multiple range images,” Image and Vision Computing, vol. 10, no. 3, pp. 145-155, April 1992, both hereby incorporated by reference; a quality check module 366 which receives the 3D face model from module 364 and decides if the face found is of good quality (using e.g. the Identix Quality Assessment Tool, Identix of Minnetonka, Minn., USA), discarding it if it is not; a face normalization module 368 operative to scale and rotate the face in preparation for creation of a token image, i.e. the transformation of the 3D image into a frontal 2D image, using for example the normalization procedure described in Israel Patent Application No. 168035; a token image creation module 370 operative to create token images from the data provided by face normalization module 368 according to a known standard (e.g. ISO 19794-5); and at least two template creation modules 372 (in this embodiment 372a and 372b), each of which receives the token image and creates a biometric template, using two different biometric algorithms. Preferably, all of these algorithms are generic and well known in the art. “generic” as used in the present invention should be understood as generally “non-proprietary”, and applies not only to biometric algorithms but also to matching engines and data fusion modules and functions. In terms of “generic” template creation, 372a may exemplarily use the well known “Fisher face” algorithm and 372b may exemplarily use the well known “Eigen face” algorithm. In alternative embodiments, at least one such algorithm is generic, the other(s) being proprietary. In yet alternative embodiments there may be different combinations of generic and proprietary biometric algorithms used in the template creation. The biometric template provided by each algorithm represents respectively extracted facial features.

Second processing unit 360 comprises a number of biometric matching engines that matches the number of template creation modules (in this case two matching engines 380 and 382) coupled to a data fusion module 384. Processing unit 360 further comprises a watch list database 386, which includes actual watch list images or biometric templates; an optional management module 388 required to manage database changes, alarm distributions, etc in case the biometric unit is connected to other units and to a server; and an optional communication module 390 that facilitates the communication between the management module and the server.

In use, each matching engine receives a respective biometric template and conducts 1:N searches against watch list database 386. The output of this search goes to the data fusion engine, where data fusion is performed for example as described in IL Patent Application No. 168091 filed 14 Apr. 2005 by Ron Zohar. titled “Generic Classification. System”, which is hereby incorporated by reference. The output of the data fusion module is a match image. We emphasize that the data fusion module can receive inputs from any two or more matching engines, and in particular from “generic” engines made available by different vendors.

By using at least two different matching engines and two different and preferably generic biometric algorithms, the outputs of the system have higher quality than systems that use only one engine or two engines with proprietary algorithms. For example, Identix has recently disclosed a system that performs data fusion using two proprietary algorithms and matching engines. In contrast, the system disclosed herein preferably uses generic biometric algorithms, which represents a significant advantage in terms of flexibility and performance optimization. Further in contrast, the system disclosed herein includes a data fusion module that can accept inputs from any two or more matching engines, including “generic” engines as defined above.

The outputs of a particular engine regarding the same subject will not be identical to those of the other engine(s). The data fusion can therefore achieve faster capabilities by sampling both engines for the same subject. If under bad surveillance conditions, a biometric matching engine might miss up to 10-15% of possible matches, the combined operation of two matching engines (done by the data fusion module that can send an engine output to a reinvestigation on another engine) can reduce the misses to about 1-2%. This procedure can not be done on a single engine system or without the data fusion module because a rerun on a same engine or with the same parameters will produce the same results.

Note that the various functions/modules divided in FIG. 3a between two processing units may be divided in a different way among a different number of processing units. Exemplarily, as shown in FIG. 3b, all the modules/functions may be incorporated in a single processing unit 394. In other embodiments (not shown), there may be three or more processing units included in a biometric unit. It is essential to understand that one of the major inventive features of the present system is the incorporation of face recognition processing functions in a stand-alone independent biometric unit, allowing this unit to function as a surveillance “system” independent of any supporting PC or server.

The Biometric Server

In embodiments in which the biometric server is connected to at least one biometric unit, the main functions of the biometric server are as follows: after receiving the list of candidates with a possible match from a biometric unit, the server processes the list by pulling the images from the data base (a replication of watch list database 386) and activating on the list an extra biometric matching engine residing in the biometric server (not shown). The extra biometric engine serves as an extra filter. The biometric engine then sends all the filtered results to the biometric data fusion module in the biometric unit. As mentioned, the data fusion module receives the results of the matching engines and fuses them. If the fusion module decides that there is a possible match (match image), it sends this information to the applications server.

The Applications Server

In embodiments in which the applications server is connected to the biometric server and at least one biometric unit, the main functions of the applications server (referred to as “client functions”) are as follows: receiving the match image from the fusion module and raises an alarm, distributing the alarm for clients that sign for it, and saving a log with all the details of biometric and demographic information from the file that relates to the match image. The applications server is also in charge of updating the watch list on each biometric end unit.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A biometric facial surveillance system comprising at least one independent, stand-alone biometric unit operative to acquire and process biometric parameters to provide a complete verification or identification of a person.

2. The system of claim 1, wherein each biometric omit includes:
a. a camera operative to provide a two dimensional (2D) video stream and a 3D pixel depth data stream, and
b. at least one processing unit operative to process the 2D video stream and the 3D pixel depth data stream into the biometric parameters.

3. The system of claim 2, wherein the at least one biometric unit includes two processing units, a first processing unit operative to provide at least two biometric templates based on at least two different biometric algorithms and a second processing unit operative to perform a face matching operation and a data fusion operation using the at least two biometric templates.

4. The system of claim 3, wherein the first processing unit includes:
i. a find face module operative to finds a face in a frame included in the camera streams;
ii. a 3D face creation module operative to create a 3D model of the face from inputs provided by the find face module and the 3D pixel depth data stream;
iii. a quality check module operative to provide a quality check on the 3D face model and to decide if it is a quality face;
iv. a face normalization module operative to normalized face data from the quality face;
v. a token image creation module operative to create token images from the normalized face data; and
vi. a plurality of template creation modules operative each to create a biometric template from the token image using a respective biometric algorithm, the biometric templates from the different template creation modules forming the analog video stream the token images

5. The system of claim 4, wherein the second processing unit includes:
i. a watch list database;
ii. a plurality of biometric matching engines that matches the plurality of template creation modules, each biometric engine operative to receive a respective biometric template and to conduct 1:N searches against the watch list database, and
iii. a data fusion module operative to exchange information with the biometric matching engines and the watch database and to perform the data fusion operation,
whereby the data fusion operation provides requested verification or identification data.

6. The system of claim 4, wherein the second processing unit optionally includes a management module operative to manage data update and exchange operations between the biometric unit and external entities, and a communication module operative to facilitate communication between the management module and the external entities.

7. The system of claim 1, further including a biometric server operative to exchange biometric information with each biometric unit and to facilitate information exchange between different biometric units.

8. The system of claim 7, further comprising an applications server functionally connected to the biometric server and operative to perform a host of client functions.

9. A biometric facial surveillance system comprising at least one independent, stand-alone biometric unit operative to acquire and process biometric parameters to provide a complete verification or identification of a person, wherein each biometric unit includes:
a, a camera operative to acquire facial information on individuals in a crowd; and
b. at least one processing unit operative to process the acquired facial information into biometric parameters used to verify or identify a specific individual, wherein the processing unit includes a data fusion module operative to fuse data obtained from two different matching engines using two different biometric algorithms.

10. The system of claim 9, wherein the system includes a single biometric unit.

11. The system of claim 9, wherein the system includes a plurality of biometric units interacting through a biometric server.

12. The system of claim 11, wherein the biometric server is functionally connected to an applications server operative to perform a host of client functions.

13. A biometric facial surveillance system comprising a stand-alone biometric unit operative to acquire biometric facial information and to process this information into a match image using a plurality of different biometric algorithms, whereby the match image can be used in the identification or verification of an individual in real time.

14. The system of claim 13, wherein the biometric unit includes:
a. a camera operative to provide biometric facial information;
b. at least one processing unit operative to process the biometric facial information using the plurality of different biometric algorithms into a matching plurality of different biometric templates;
c. a plurality of matching engines, each engine operative to receive a respective biometric template, each engine operative to conduct 1:N searches against a watch list database and to provide a respective matching engine output; and
d. a data fusion module operative to fuse the matching engine outputs with data obtained from a watch list in order to provide the match image.

15. The system of claim 13, wherein at least one of the biometric algorithms is generic.

16. The system of claim 13 wherein all the biometric algorithms are generic.

17. A method for obtaining real time identification or verification of a person based on biometric facial information, comprising the steps of
a. providing a stand-alone biometric unit; and
b. operating the biometric unit to acquire biometric facial information and to process this information into a match image using a plurality of different biometric algorithms, whereby the match image can be used in the real time identification or verification.

18. The method of claim 17, wherein the step of providing a stand-alone biometric unit comprises providing a biometric unit that includes:
a. a camera operative to provide biometric facial information;
b. at least one processing unit operative to process the biometric facial information using the plurality of different biometric algorithms into a matching plurality of different biometric templates;
c. a plurality of matching engines, each engine operative to receive a respective biometric template, each engine operative to conduct 1:N searches against a watch list database and to provide a respective matching engine output; and
d. a data fusion module operative to fuse the matching engine outputs with data obtained from a watch list in order to provide the match image.

19. The method of claim 17, wherein the using a plurality of different facial recognition algorithms includes using a plurality of different generic algorithms.

20. The method of claim 17, wherein the using a plurality of different facial recognition algorithms includes using a plurality of different algorithms of which at least one is generic.
